(19) United States
(12) Patent Application Publication
(10) Pub. No.: US 2013/0329806 A1
(43) Pub. Date: Dec. 12, 2013

(54) BI-LAYER TEXTURE PREDICTION FOR VIDEO CODING

(71) Applicant: QUALCOMM Incorporated, San Diego, CA (US)

(72) Inventors: Chengjie TU, San Diego, CA (US); Jianle CHEN, San Diego, CA (US); Xianglin WANG, San Diego, CA (US); Marta KARCZEWICZ, San Diego, CA (US)

(21) Appl. No.: 13/910,023

(22) Filed: Jun. 4, 2013

Related U.S. Application Data
(60) Provisional application No. 61/657,541, filed on Jun. 8, 2012.

(51) Int. Cl. H04N 7/26

(52) U.S. Cl. CPC H04N 19/00951
USPC 375/240.18; 375/240.24

(57) ABSTRACT

In one example, an apparatus is configured to code video data. The apparatus comprises a processor configured to determine a base layer reference block for a current block. The base layer reference block may be located in the base layer. The processor is further configured to determine an enhancement layer reference block for the current block. The enhancement layer reference block may comprise a weighted sum of a first reference block located in the enhancement layer and a second reference block located in the enhancement layer. The processor is further configured to determine a reference block from the base layer reference block and the enhancement layer reference block.

### CROSS-REFERENCE TO RELATED APPLICATIONS

This application claims priority to U.S. Provisional Application No. 61/657,541, entitled “BI-LAYER TEXTURE PREDICTION FOR VIDEO CODING” and filed on Jun. 8, 2012, which is hereby incorporated by reference in its entirety.

### TECHNICAL FIELD

This disclosure relates to video coding and compression and, in particular, to scalable video coding (SVC).

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. The video devices may transmit, receive, encode, decode, and/or store digital video information more efficiently by implementing such video coding techniques.

Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. Extensions of video standards include, for example, the scalable video coding (SVC) extension of H.264/AVC and the multiview video coding (MVC) extension of H.264/AVC. Scalable video coding and multiview video coding extensions have also been proposed for HEVC.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for bi-layer texture prediction for video coding, e.g., for scalable video coding (SVC) techniques. That is, this disclosure describes techniques for predicting a current block using both data of a lower layer, such as a base layer or lower enhancement layer, and data of the current enhancement layer.

One aspect of this disclosure provides an apparatus configured to code video data. The apparatus comprises a memory configured to store the video data. The video data may comprise a base layer and an enhancement layer. The enhancement layer may comprise a current block. The apparatus further comprises a processor in communication with the memory, the processor configured to determine a base layer reference block for the current block. The base layer reference block may be located in the base layer. The processor may be further configured to determine an enhancement layer reference block for the current block. The enhancement layer reference block may comprise a weighted sum of a first reference block located in the enhancement layer and a second reference block located in the enhancement layer. The processor may be further configured to determine a reference block from the base layer reference block and the enhancement layer reference block.

Another aspect of this disclosure provides a method of decoding video data. The method comprises receiving syntax elements extracted from an encoded video bit stream. The method further comprises determining a base layer reference block for a current block based on the syntax elements. The current block may be located in an enhancement layer of the video data. The base layer reference block may be located in a base layer of the video data. The method further comprises determining an enhancement layer reference block for the current block based on the syntax elements. The enhancement layer reference block may comprise a weighted sum of a first reference block located in the enhancement layer and a second reference block located in the enhancement layer. The method further comprises determining a reference block from the base layer reference block and the enhancement layer reference block. The method further comprises determining a reconstructed block based on the reference block and residual data extracted from the encoded video bit stream.

Another aspect of this disclosure provides a method of encoding video data. The method comprises determining a base layer reference block for a current block. The current block may be located in an enhancement layer of the video data. The base layer reference block may be located in a base layer of the video data. The method further comprises determining an enhancement layer reference block for the current block. The enhancement layer reference block may comprise a weighted sum of a first reference block located in the enhancement layer and a second reference block located in the enhancement layer. The method further comprises determining a reference block from the base layer reference block and the enhancement layer reference block. The method further comprises determining residual data based on the reference block and pixel values of the current block.

Another aspect of this disclosure provides a non-transitory computer readable medium having stored thereon code that, when executed, causes an apparatus to determine a base layer reference block for a current block. The current block may be located in an enhancement layer of video data. The base layer reference block may be located in a base layer of the video data. The medium further has stored thereon code that, when executed, causes an apparatus to determine an enhancement layer reference block for the current block. The enhancement layer reference block may comprise a weighted sum of a first reference block located in the enhancement layer and a second reference block located in the enhancement layer. The medium further has stored thereon code that, when executed, causes an apparatus to determine a reference block from the base layer reference block and the enhancement layer reference block.

Another aspect of this disclosure provides a video coding device that codes video data. The video coding device comprises means for determining a base layer reference block for a current block. The current block may be located in an enhancement layer of video data. The base layer reference block may be located in a base layer of the video data. The video coding device further comprises means for determining an enhancement layer reference block for the current block. The enhancement layer reference block may comprise a weighted sum of a first reference block located in the enhancement layer and a second reference block located in the enhancement layer. The video coding device further comprises means for determining a reference block from the base layer reference block and the enhancement layer reference block.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques for performing bi-layer texture prediction.

FIG. 2 is a block diagram illustrating an example of a video encoder that may implement techniques for performing bi-layer texture prediction.

FIG. 3 is a block diagram illustrating an example of a video decoder that may implement techniques for performing bi-layer texture prediction.

FIG. 4 is a conceptual diagram illustrating an example current block predicted using intra-prediction.

FIG. 5 is a conceptual diagram illustrating an example current block that is predicted using inter-prediction.

FIG. 6 is a conceptual diagram illustrating an example scalable video coding (SVC) prediction structure in accordance with the techniques of this disclosure.

FIG. 7 is a conceptual diagram illustrating an example current block of an enhancement layer that is predicted from data of a lower layer.

FIG. 8A is a conceptual diagram illustrating a block in an enhancement layer predicted from data of a base layer and data of the enhancement layer.

FIG. 8B is another conceptual diagram illustrating a block in an enhancement layer predicted from data of a base layer and data of the enhancement layer.

FIG. 8C is another conceptual diagram illustrating a block in an enhancement layer predicted from data of a base layer and data of the enhancement layer.

FIG. 9 is a flowchart illustrating an example method for encoding a current block using bi-layer texture prediction.

FIG. 10 is a flowchart illustrating an example method for decoding a current block of video data using bi-layer texture prediction.

FIG. 11 is another flowchart illustrating an example method for decoding a block a current block of video data using bi-layer texture prediction.

FIG. 12 is another flowchart illustrating an example method for encoding a current block using bi-layer texture prediction.

### DETAILED DESCRIPTION

A video sequence is generally represented as a sequence of pictures. Typically, block-based coding techniques are used to code each of the individual pictures. That is, each picture is divided into blocks, and each of the blocks is individually coded. Coding a block of video data generally involves forming a predicted value for the block and coding a residual value, that is, the difference between the original block and the predicted value. Specifically, the original block of video data includes a matrix of pixel values, and the predicted value includes a matrix of predicted pixel values. The residual value corresponds to pixel-by-pixel differences between the pixel values of the original block and the predicted pixel values.

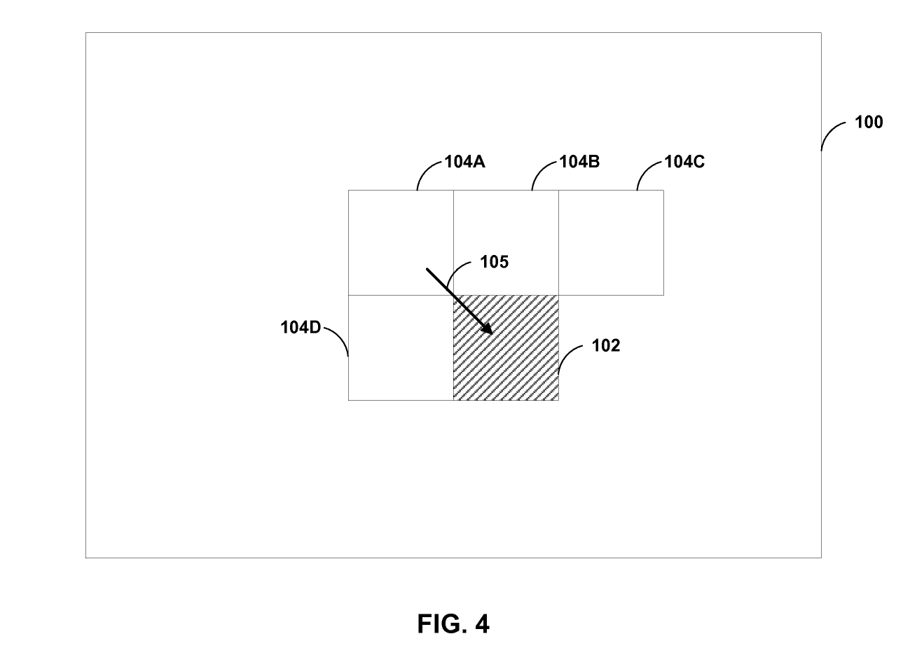

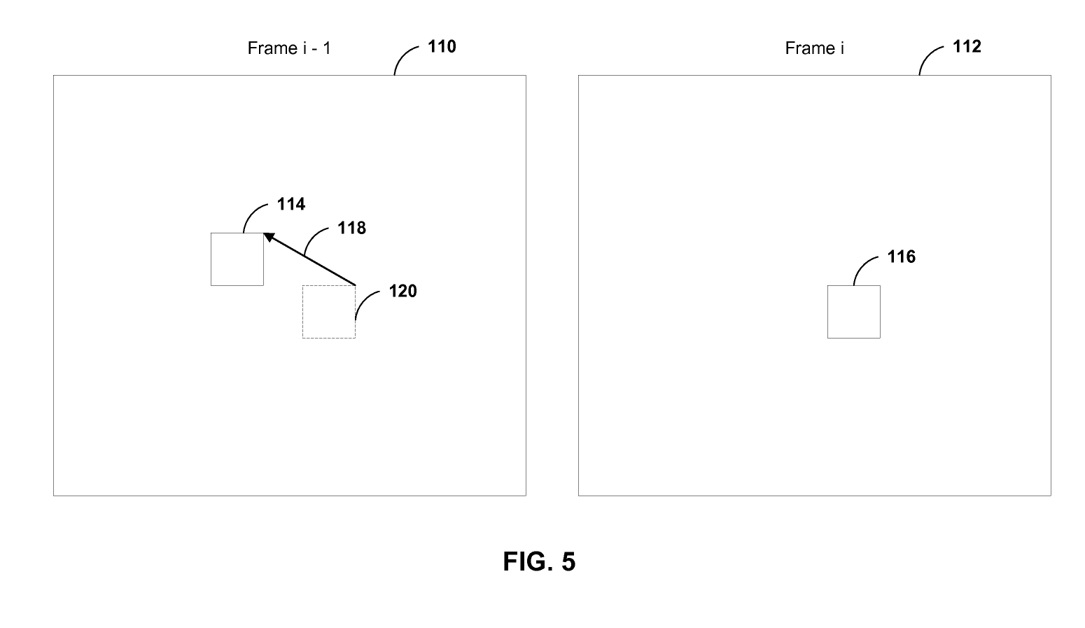

Prediction techniques for a block of video data are generally categorized as intra-prediction and inter-prediction. Intra-prediction, or spatial prediction, generally involves predicting the block from pixel values of neighboring, previously coded blocks. An example of intra-prediction is discussed in greater detail with respect to FIG. 4 below. Inter-prediction, or temporal prediction, generally involves predicting the block from pixel values of previously coded pictures. The previously coded pictures may represent pictures that are displayed earlier or later than the picture being coded. In other words, the display order for pictures is not necessarily the same as the decoding order of the pictures, and thus, pictures displayed earlier or later than the current picture being coded may be used as reference for coding blocks of the current picture. An example of inter-prediction is discussed in greater detail with respect to FIG. 5 below.

A residual block includes values representative of pixel-by-pixel differences between the original block and a predicted value for the original block. These values are, accordingly, expressed in a pixel domain. A video encoder may apply a transform, such as a discrete cosine transform (DCT), to these values, thereby expressing values in a transform domain, such as a frequency domain. These values in the frequency domain are referred to as transform coefficients. The video encoder may further quantize the transform coefficients, resulting in quantized transform coefficients. Moreover, the video encoder may entropy encode the quantized transform coefficients.

As an example, referring to a current block as “O,” a reference block for O as “R,” and a residual block as “E,” to encode block O, E is transformed, quantized, and entropy coded, where E is calculated according to formula (1) below:

E=O−R (1)

In HEVC, a basic coding block is a coding unit (CU), to which various coding tools may be applied for potential video compression. A CU may split into smaller blocks for prediction (prediction units or PUs). A CU can have one of the two prediction modes: INTRA mode and INTER mode. Intra-prediction mode is explained in greater detail with respect to FIG. 4, while inter-prediction mode is explained in greater detail with respect to FIG. 5.

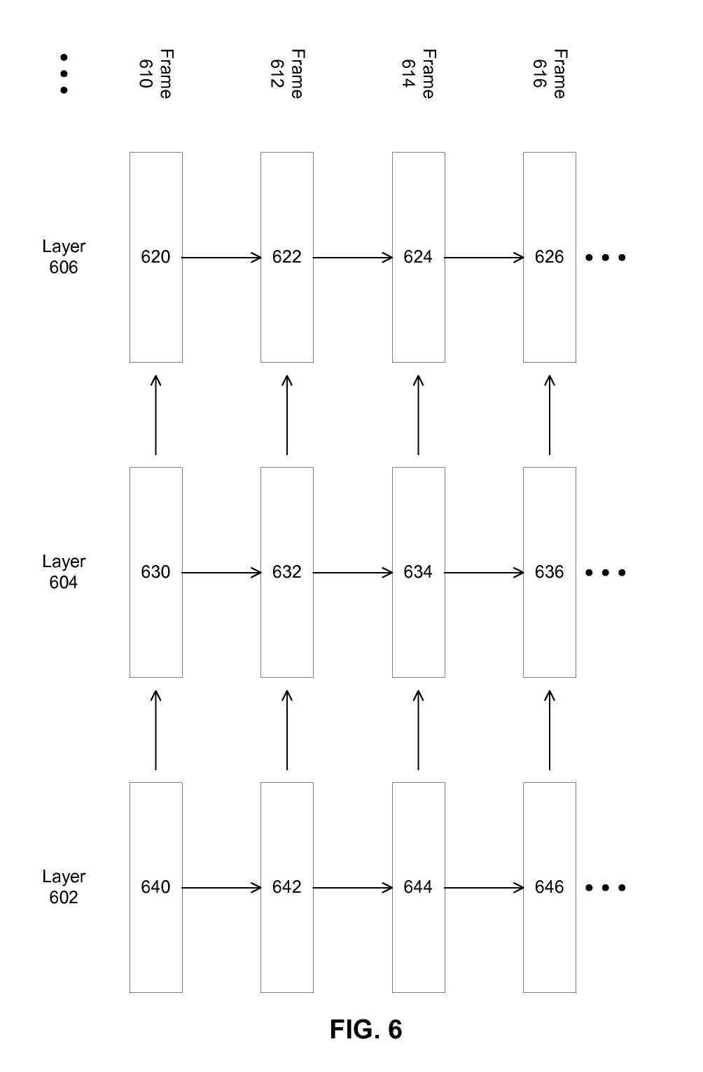

Scalable video coding (SVC) includes various techniques for dividing video data into layers, such as a base layer and one or more enhancement layers. For example, the base layer may include video data at a relatively lower quality than the original data, a lower spatial resolution than the original video data, and/or at a lower frame rate than the original video data. The enhancement layers may include data for enhancing the base layer (e.g., to more accurately reproduce video data at the spatial resolution and/or frame rate of the original video data). SVC is explained in greater detail below with respect to FIG. 6.

Thus, certain devices may elect to obtain only the base layer video data (e.g., when network bandwidth for transmitting video data is particularly limited). Similarly, if data of an enhancement layer is lost or corrupted, such loss or corruption does not necessarily result in a total loss of the video data, in that the receiving device may simply decode and display video data of the base layer. In this manner, SVC may support quality, spatial, and/or temporal scalability, such that one encoded video bitstream can support devices of various coding and/or rendering capabilities.

Typically, a block of video data at a particular enhancement layer can be predicted from other data at the same enhancement layer (e.g., another block in the enhancement layer) or from a co-located block at a layer immediately below the enhancement layer. For example, the data at the same enhancement layer or data from a co-located block at a layer immediately below the enhancement layer may have some pixels that are close to the original pixels in the block of video data at the enhancement layer. However, the data at the same enhancement layer or data from a co-located block at a layer immediately below the enhancement layer may have some pixels that are not close to the original pixels in the block of video data at the enhancement layer. Furthermore, the residuals generated using the data from the same enhancement layer or the data from the co-located block may not be smooth (e.g., there may be large variations in the residual values) and thus compression may be difficult.

The residuals may be smoother, and therefore easier to compress, when two blocks are used to predict a block of video data at a particular enhancement layer. However, current video codecs only allow the use of two blocks when both blocks reside in the same layer (e.g., both reside in the same enhancement layer or both reside in the layer immediately below the enhancement layer).

Thus, this disclosure describes techniques for predicting a block of video data at a particular layer using bi-prediction, such that the block is predicted from data of pictures at different layers. In other words, the block may be predicted using data of both the current layer and data of a lower layer. In this way, a larger number of pixels that are closer to the original pixels of the block to be predicted may be used, thereby generating smoother residuals and easier compression.

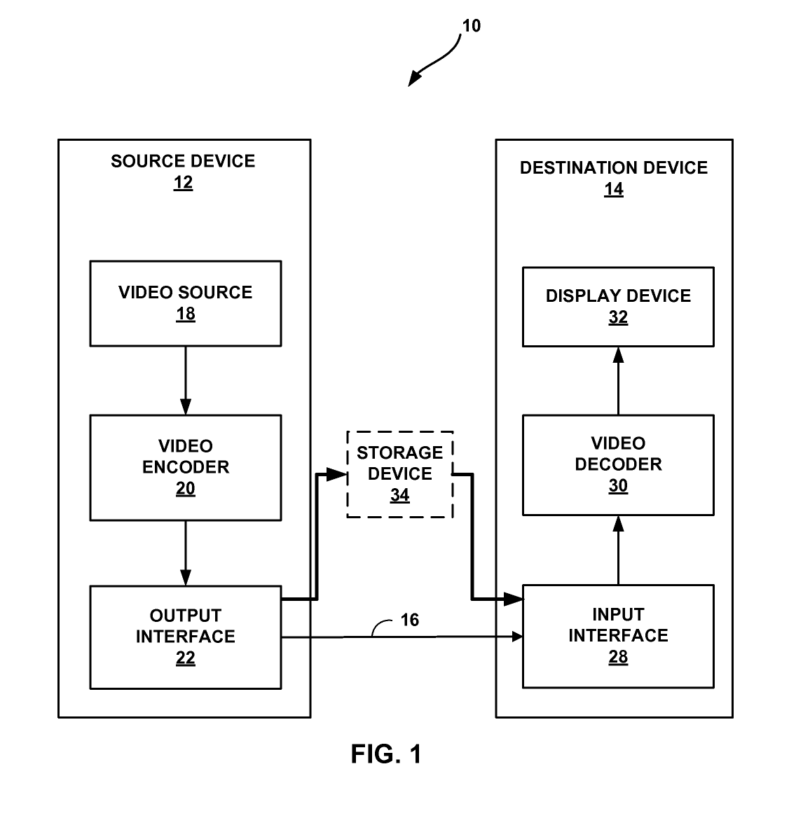

FIG. 1 is a block diagram illustrating an example video encoding and decoding system 10 that may utilize techniques for performing bi-layer texture prediction. As used herein, the term “video coder” refers generically to both video encoders and video decoders. In this disclosure, the terms “video coding” or “coding” may refer generically to video encoding and video decoding.

As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (e.g., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to an optional storage device 34. Similarly, encoded data may be accessed from the storage device 34 by input interface 28. The storage device 34 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device 34 may correspond to a file server or another intermediate storage device that may store the encoded video generated by source device 12. Destination device 14 may access stored video data from the storage device 34 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device 34 may be a streaming transmission, a download transmission, or a combination thereof

The techniques of this disclosure are not limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of source device 12 may be configured to apply the techniques for performing bi-layer texture prediction. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for performing bi-layer texture prediction may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14 (e.g., for video streaming, video playback, video broadcasting, or video telephony).

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14 (e.g., via network transmission). Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units (e.g., a group of pictures (GOPs)). Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 may operate according to a video coding standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video coding standards include MPEG-2 and ITU-T H.263. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. The Joint Video Team (JVT) continues to work on extensions to H.264/MPEG-4 AVC.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes. A recent draft of the upcoming HEVC standard, referred to as “HEVC Working Draft 7” or “WD7,” is described in document HCTVC-I1003, Bross et al., “High Efficiency Video Coding (HEVC) Text Specification Draft 7,” Joint Collaborative Team on Video Coding (JCT-VC) of ITU-T SG16 WP3 and ISO/IEC JTC1/SC29/WG11, 9th Meeting: Geneva, Switzerland, Apr. 27, 2012 to May 7, 2012, which, as of Jun. 6, 2102, is downloadable from http ://phenix.it-sudparis.eu/jct/doc_end_user/documents/9_Geneva/wg11/JCTVC-I1003-v3.zip.

In general, the working model of the HM describes that a video frame or picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

A leaf-CU having one or more PUs may also include one or more transform units (TUs). The transform units may be specified using an RQT (also referred to as a TU quadtree structure), as discussed above. For example, a split flag may indicate whether a leaf-CU is split into four transform units. Then, each transform unit may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

In accordance with the techniques of this disclosure, a video coder, such as video encoder 20 or video decoder 30, may be configured to perform bi-layer texture prediction. That is, the video coder may be configured to predict a current block of an enhancement layer using data of the enhancement layer and data of a lower layer (e.g., a base layer or a lower enhancement layer). Conventional bi-prediction uses a weighted sum of two blocks as reference, which has been proven to be useful. That is, conventionally, bi-prediction has involved predicting a current block using two reference blocks of two different reference pictures at the same layer as the current block. Each reference block may include pixels closer to (e.g., that more closely match) the pixels of the original block (e.g., a current block being coded) than the other reference block. Thus, the weighted sum may produce a predicted block that is better (e.g., more closely matches the current block) than either of the two reference blocks. Furthermore, the bi-prediction residuals may be smoother (e.g., there may be fewer variations in the residual values) and thus easier to compress.

In current video codecs, bi-prediction only happens in one layer. To predict texture of a PU, there is not a way to take advantage of both layers at the same time. In accordance with the techniques of this disclosure, however, a video coder may code a current block using data of two different layers. For example, a video coder may form a predicted block for a current block of an enhancement layer using data of a lower layer (e.g., a base layer or a lower enhancement layer) and data of the current enhancement layer. The data of the current enhancement layer may correspond to data that is predicted using intra-prediction, uni-directional inter-prediction, or bi-directional inter-prediction. In this manner, the techniques of this disclosure extend the conventional bi-prediction concept to two layers in scalable video coding.

To predict texture of an enhancement layer PU, a video coder may calculate a reference block (also referred to as a predicted block) for the PU, where the reference block corresponds to a weighted sum of two blocks:

R=w_{B}*R_{B}+(1−w_{B})*R_{E} (2)

In the example of formula (2), R corresponds to a reference block for a current block (e.g., a current PU), R_{B} corresponds to a block in a layer below the enhancement layer, such as the base layer or a lower enhancement layer, w_{B} describes a weighting value applied to R_{B}, and R_{E} corresponds to a reference block in the enhancement layer. It should be understood that R_{E} may be a reference block formed according to intra-prediction, uni-directional inter-prediction, or bi-directional inter-prediction. These techniques are referred to herein as bi-layer texture prediction because R is a weighted sum of blocks from two layers: one from a base layer (e.g., a layer below a current enhancement layer) and one from the current enhancement layer.

Typically, the weight W_{B} is fixed in a PU. An example value of w_{B} could be 0.5 as a simple design. To achieve better performance, the video coder may adaptively select the w_{B} value based on base layer and enhancement layer quality. The video coder may code a value representative of w_{B} in a slice header, sequence parameter set (SPS) (e.g., a sequence header), picture parameter set (PPS) (e.g., a picture header), adaptation parameter set (APS), or other such data structure. Alternatively, the video coder may code a value for w_{B} at any of the LCU/CU/PU level. As still another example, the video coder may code values for W_{B} at any combination of these levels, where a value signaled for w_{B} at a lower level overrides a value signaled for w_{B} at a higher level.

In some examples, the weight w_{B} could be different for individual pixels of different positions in a PU. In one example, when a PU is predicted based on a base layer reference block R_{B} and an enhancement layer intra-predicted reference block R_{E}, a larger weight value may be assigned to pixels which are closer to the left and/or top of the PU boundary (e.g., because the pixels closer to the left and/or top of the PU boundary may be more precise than the pixels closer to the right and/or bottom of the PU boundary). Thus, the value of W_{B} may vary as a function of a prediction type for a reference block R_{E} of a PU.

Although R_{B} is described above as corresponding to a co-located block to the current block, in other examples data from a lower layer may be selected in other ways. For example, a video coder may be configured to select one or more reference blocks for a PU in an enhancement layer from pictures at a lower layer using techniques similar to inter-prediction (e.g., uni-directional and/or bi-directional inter-prediction). Thus, R_{B} may, in such examples, refer to a reference block formed using inter-prediction at a lower layer for a block that is co-located with the current block in the enhancement layer. In some examples, the lower layer has a lower spatial resolution than the enhancement layer. Thus, a video coder may upsample data of the lower layer for a co-located block or other reference block in the lower layer, to calculate a value for R_{B}.

Video encoder 20 may further send syntax data, such as block-based syntax data, frame-based syntax data, and GOP-based syntax data, to video decoder 30 (e.g., in a frame header, a block header, a slice header, or a GOP header). The GOP syntax data may describe a number of frames in the respective GOP, and the frame syntax data may indicate an encoding/prediction mode used to encode the corresponding frame.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). A device including video encoder 20 and/or video decoder 30 may comprise an integrated circuit, a microprocessor, and/or a wireless communication device, such as a cellular telephone.

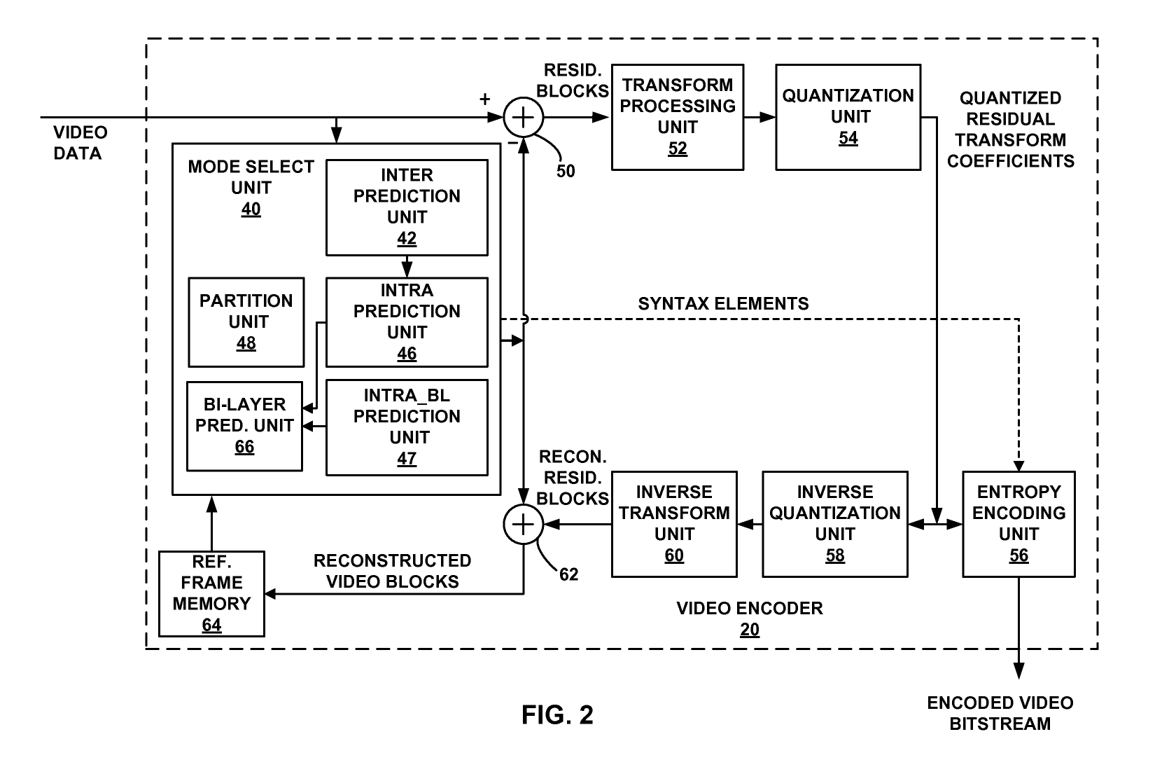

FIG. 2 is a block diagram illustrating an example of video encoder 20 that may implement techniques for performing bi-layer texture prediction. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block within a video frame to be encoded. In the example of FIG. 2, video encoder 20 includes mode select unit 40, reference frame memory 64, summer 50, transform processing unit 52, quantization unit 54, and entropy coding unit 56. Mode select unit 40, in turn, includes inter-prediction unit 42, intra-prediction unit 46, intra_bl-prediction unit 47, bi-layer prediction unit 66, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. The inter-prediction unit 42 may include a motion estimation unit and a motion compensation unit (not shown). The motion estimation unit and the motion compensation unit perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Intra_bl-prediction unit 47 may alternatively perform intra_bl-predictive coding of the received video block relative to one or more co-located blocks in the same frame or slice as the block to be coded. Video encoder 20 may perform multiple coding passes (e.g., to select an appropriate coding mode for each block of video data).

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter (e.g., based on error results) and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy coding unit 56. In general, the motion compensation unit and intra-prediction unit 46 generate predictive data for a current block using data at the same layer as the current block. As explained below, bi-layer prediction unit 66 may retrieve data from a lower layer, relative to the layer of the current block, when the current block is in an enhancement layer.

The motion estimation unit and the motion compensation unit of the inter-prediction unit 42 may be highly integrated or may be separate. Motion estimation, performed by the motion estimation unit, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, the motion estimation unit may perform a motion search relative to the full pixel positions and fractional pixel positions and output a motion vector with fractional pixel precision.

The motion estimation unit calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference frame memory 64. The motion estimation unit sends the calculated motion vector to entropy encoding unit 56 and the motion compensation unit.

Motion compensation, performed by the motion compensation unit, may involve fetching or generating the predictive block based on the motion vector determined by the motion estimation unit. Again, the motion estimation unit and the motion compensation unit may be functionally integrated, in some examples. Upon receiving the motion vector for the PU of the current video block, the motion compensation unit may locate the predictive block to which the motion vector points in one of the reference picture lists. Summer 50 forms a residual video block by subtracting pixel values of the predictive block from the pixel values of the current video block being coded, forming pixel difference values, as discussed below. In general, the motion estimation unit performs motion estimation relative to luma components, and the motion compensation unit uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by the motion estimation unit and the motion compensation unit, as described above. In particular, intra-prediction unit 46 may determine an intra-prediction mode to use to encode a current block. In some examples, intra-prediction unit 46 may encode a current block using various intra-prediction modes (e.g., during separate encoding passes) and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy coding unit 56. Entropy coding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Intra_bl-prediction unit 47 may intra_bl-predict a current block. In particular, intra_bl-prediction unit 47 may determine an intra_bl-prediction mode to use to encode a current block. In some examples, intra bl-prediction unit 47 may encode a current block using a co-located block in a lower layer of the same frame or slice as the current block.

The intra_bl-prediction unit 47 may provide information indicative of the intra_bl-prediction mode for the block to entropy coding unit 56. Entropy coding unit 56 may encode the information indicating the intr_bl-prediction mode. Video encoder 20 may include in the transmitted bitstream configuration data, which may include a plurality of intra_bl-prediction mode index tables and a plurality of modified intra_bl-prediction mode index tables (also referred to as codeword mapping tables), definitions of encoding contexts for various blocks, and indications of a most probable intra_bl-prediction mode, an intra_bl-prediction mode index table, and a modified intra_bl-prediction mode index table to use for each of the contexts.

In accordance with the techniques of this disclosure, bi-layer prediction unit 66 retrieves data from a lower layer when video encoder 20 is encoding data of an enhancement layer. For example, when coding a PU of an enhancement layer, bi-layer prediction unit 66 may retrieve data for a block that is co-located with the PU in a lower layer (e.g., from reference frame memory 64). Data from the lower layer for the current PU is referred to as R_{B} in this disclosure. Bi-layer prediction unit 66 may combine data for R_{B} with prediction data (R_{E}) formed by inter prediction unit 42, intra-prediction unit 46, and/or intra_bl-prediction unit 47. In particular, the bi-layer prediction unit 66 may receive information from the intra_bl prediction unit 47 and from the intra-prediction unit 46 and/or the inter-prediction unit 42. Bi-layer prediction unit 66 may also be configured with weight values to apply to the reference blocks (e.g., R_{B} and/or _{RE})_{,} or individual pixels thereof. In some examples, mode select unit 40 may cause bi-layer prediction unit 66 to select an appropriate weight (e.g., based on a prediction mode selected for calculating predicted data at the current layer (that is, R_{E})). In this manner, bi-layer prediction unit 66 of video encoder 20 may be configured to calculate formula (2) described above (e.g., determine reference block R), in accordance with the techniques of this disclosure. Bi-layer prediction unit 66 may also code values representative of weight values (e.g., to be included in a slice header, an SPS (e.g., a sequence header), a PPS (e.g., a picture header), an APS, or other such data structure).

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used.

In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy coding unit 56 entropy codes the quantized transform coefficients. For example, entropy coding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy coding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain (e.g., for later use as a reference block). The motion compensation unit may calculate a reference block by adding the residual block to a predictive block of one of the frames of reference frame memory 64. The motion compensation unit may also apply one or more interpolation filters to the reconstructed residual block to calculate sub-integer pixel values for use in motion estimation. Summer 62 adds the reconstructed residual block to the motion compensated prediction block produced by the motion compensation unit to produce a reconstructed video block for storage in reference frame memory 64. The reconstructed video block may be used by the motion estimation unit and the motion compensation unit as a reference block to inter-code a block in a subsequent video frame.

In this manner, video encoder 20 of FIG. 2 represents an example of a video encoder configured to calculate a base layer reference block for a current block of an enhancement layer of video data, calculate an enhancement layer reference block for the current block, combine the base layer reference block and the enhancement layer reference block to form an actual reference block, and code the current block using the actual reference block.

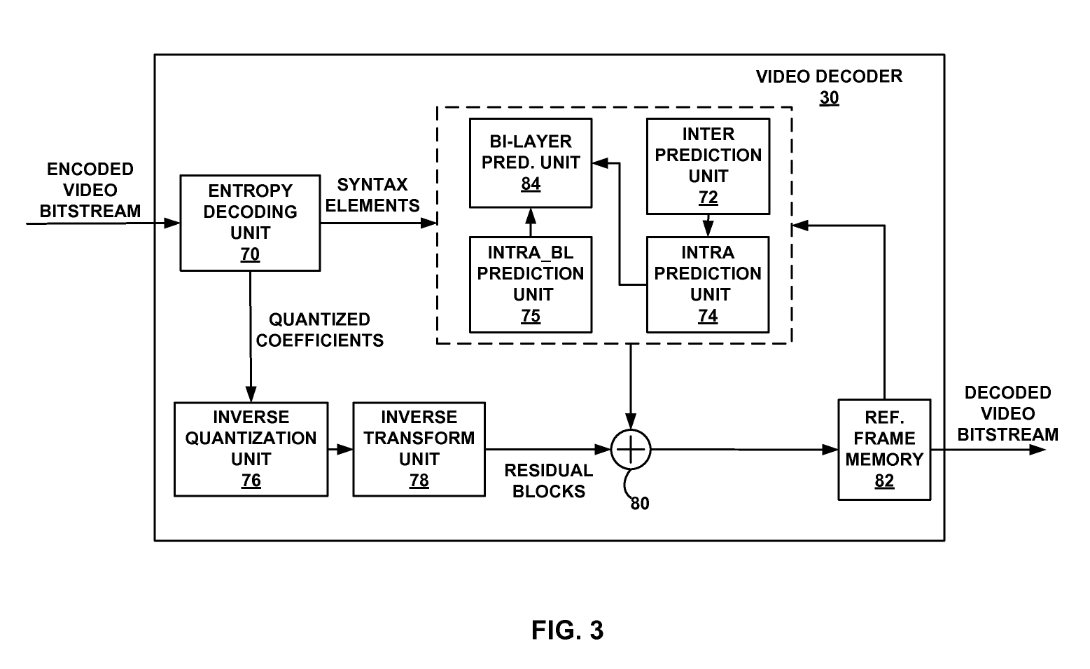

FIG. 3 is a block diagram illustrating an example of video decoder 30 that may implement techniques for performing bi-layer texture prediction. In the example of FIG. 3, video decoder 30 includes an entropy decoding unit 70, inter-prediction unit 72, intra-prediction unit 74, intra_bl-prediction unit 75, inverse quantization unit 76, inverse transformation unit 78, bi-layer prediction unit 84, reference frame memory 82 and summer 80. Video decoder 30 may, in some examples, perform a decoding pass generally reciprocal to the encoding pass described with respect to video encoder 20 (FIG. 2). The inter-prediction unit 72 may include a motion compensation unit that generates prediction data based on motion vectors received from entropy decoding unit 70, while intra-prediction unit 74 may generate prediction data based on intra-prediction mode indicators received from entropy decoding unit 70 and intra_bl prediction unit 75 may generate prediction data based on intra_bl-prediction mode indicators received from entropy decoding unit 70.

In accordance with the techniques of this disclosure, bi-layer prediction unit 84 combines the predicted data from inter-prediction unit 72 and/or intra-prediction unit 74 with data from a layer below a current layer (e.g., provided by intra_bl-prediction unit 75), when a current block forms part of an enhancement layer. Thus, bi-layer prediction unit 84 may be configured to form predictive data for a current block (e.g., a current PU) at an enhancement layer in a manner that conforms substantially to that of bi-layer prediction unit 66 (FIG. 2). In this manner, bi-layer prediction unit 84 of video decoder 30 may be configured to calculate formula (2) described above (e.g., determine reference block R), in accordance with the techniques of this disclosure.

Moreover, bi-layer prediction unit 84 may receive syntax elements signaled in, for example, a slice header, an SPS (e.g., a sequence header), a PPS (e.g., a picture header), an APS, or other data structure, related to bi-layer texture prediction. For example, bi-layer prediction unit 84 may receive values indicative of weights to be applied to pixels of the various reference blocks (e.g., R_{B} and R_{E}).

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to inter-prediction unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (e.g., B, P or GPB) slice, inter-prediction unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference frame memory 82.

When the video slice is coded as an intra_bl-coded slice, intra_bl-prediction unit 75 may generate prediction data for a video block of the current video slice based on a signaled intra_bl prediction mode and data from one or more co-located blocks of a lower layer in the current frame or picture.

The inter-prediction unit 72 determines prediction information for a video block of the current video slice by parsing the motion vectors and other syntax elements, and uses the prediction information to produce the predictive blocks for the current video block being decoded. For example, the inter-prediction unit 72 uses some of the received syntax elements to determine a prediction mode (e.g., intra-, intra_bl- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

The inter-prediction unit 72 may also perform interpolation based on interpolation filters. The inter-prediction unit 72 may use interpolation filters as used by video encoder 20 during encoding of the video blocks to calculate interpolated values for sub-integer pixels of reference blocks. In this case, the inter-prediction unit 72 may determine the interpolation filters used by video encoder 20 from the received syntax elements and use the interpolation filters to produce predictive blocks.

Inverse quantization unit 76 inverse quantizes (e.g., de-quantizes) the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied. Inverse transform unit 78 applies an inverse transform (e.g., an inverse DCT, an inverse integer transform, or a conceptually similar inverse transform process) to the transform coefficients in order to produce residual blocks in the pixel domain.

After the inter-prediction unit 72 generates the predictive block for the current video block based on the motion vectors and other syntax elements, video decoder 30 forms a decoded video block by summing the residual blocks from inverse transform unit 78 with the corresponding predictive blocks generated by the inter-prediction unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 82, which stores reference pictures used for subsequent motion compensation. Reference frame memory 82 also stores decoded video for later presentation on a display device, such as display device 32 of FIG. 1.

In this manner, video decoder 30 of FIG. 3 represents an example of a video decoder configured to calculate a base layer reference block for a current block of an enhancement layer of video data, calculate an enhancement layer reference block for the current block, combine the base layer reference block and the enhancement layer reference block to form an actual reference block, and code the current block using the actual reference block.

FIG. 4 is a conceptual diagram illustrating an example current block 102 predicted using intra-prediction. In this example, picture 100 includes blocks 104A-104D (blocks 104) and current block 102. Blocks 104 may be referred to as previously coded blocks, in that blocks 104 are coded prior to coding current block 102. That is, blocks in picture 100 (or other sub-picture structure, such as a slice, tile, or wavefront) may be coded in raster scan order (e.g., top-to-bottom, left-to-right order). Accordingly, blocks 104 include data that may be used to intra-predict current block 102. Various intra-prediction directions may be used to intra-predict current block 102 from one of blocks 104. For example, arrow 105 shown in FIG. 4 represents an intra-prediction direction to intra-predict current block 102 from one of blocks 104.

A PU in an intra-coded CU is predicted spatially from previously reconstructed neighboring pixels from the same picture or sub-picture unit (e.g., a slice, tile, or wavefront). Multiple intra-prediction directions are provided in HEVC, and a video coder codes signaling data in the bitstream representative of a selected intra-prediction direction. For example, video encoder 20 may test various intra-prediction modes and select an intra-prediction mode for coding block 102 that results in the best coding performance from these tests. Different PUs in an intra-coded CU may have different prediction directions.

In accordance with the techniques of this disclosure, block 102 may correspond to a PU in an enhancement layer frame. A video coder, such as video encoder 20 or video decoder 30, may form an enhancement layer reference block (R_{E}) for block 102 using intra-prediction, as shown in FIG. 4 with arrow 105. Moreover, in accordance with the techniques of this disclosure, the video coder may combine the data of R_{E} with a reference block formed from lower layer data, such as a block that is co-located with block 102 in a lower layer (e.g., a base layer or lower enhancement layer) to form a predicted block for block 102.

FIG. 5 is a conceptual diagram illustrating an example current block 116 that is predicted using inter-prediction. A PU in an inter-prediction coded CU is predicted temporally from a block, or two weighted blocks, in one or more previously decoded pictures (in decoded order). Such blocks may be referred to as reference blocks. The motion information that identifies the reference block or blocks (e.g., data for one or more motion vectors) may be signaled in the bitstream. Different PUs in an inter-prediction coded CU (that is, different PUs of the same CU) may have different motion information.

Uni-prediction (or uni-directional prediction) refers to predicting an inter-predicted PU using one block in a previously coded picture. Bi-prediction (or bi-directional prediction) refers to predicting an inter-predicted PU using two blocks in two respective previously coded picture. Thus, an inter-predicted PU can be predicted from two blocks R₁ and R₂ in previously coded pictures, which again, may be referred to as bi-prediction. In this case, a reference block R may be formed as a weighted sum of two blocks using formula (3) below, where w is the weight:

R=w*R₁+(1−w)*R₂ (3)

It should be understood that when a block is predicted, pixel values are predicted for pixel values of the block being predicted. Thus, R₁ and R₂ include blocks of pixel values, which are combined using formula (3) above to produce a block of pixel prediction values for the current block, that is, the current PU.

In this example, picture 112 includes current block 116. Block 116 is uni-directionally predicted from reference block 114 of picture 110. Motion vector 118 points from block 120 of picture 110, which is spatially co-located with current block 116 of picture 112, to reference block 114 to show the displacement in distance from block 120 to reference block 114. Additional motion information for current block 116 may include identifying information for picture 112, such as a picture order count (POC) value or a frame number (frame num) of picture 112. In this manner, a video coder, such as video encoder 20 or video decoder 30, can use the motion vector and the picture identifying information to locate a reference block in a reference picture.

In accordance with the techniques of this disclosure, current block 116 may correspond to a PU in an enhancement frame. A video coder, such as video encoder 20 or video decoder 30, may form an enhancement layer reference block (R_{E}) for current block 116 using uni-directional inter-prediction, as shown in FIG. 5. Alternatively, the video coder may form R_{E} using bi-directional inter-prediction (e.g., by combining two reference blocks from two different reference pictures in the same layer as picture 110). Specifically, pixel values of the two reference blocks are combined to form predicted pixel values. Moreover, in accordance with the techniques of this disclosure, the video coder may combine the data of R_{E} with a reference block formed from lower layer data, such as a block that is co-located with current block 116 in a lower layer, to form a predicted block for current block 116.

FIG. 6 is a conceptual diagram illustrating an example SVC prediction structure in accordance with the techniques of this disclosure. For SVC, there is one absolute base layer (layer 602) and one or multiple enhancement layers (layer 604, 606 . . . etc.) Each enhancement layer 604 or 606 may serve as a base layer for other layers above it. For example, as shown in FIG. 6, layer 604 is an enhancement layer relative to layer 602, but it may also serve as a base layer for layer 606. Relative to its base layer, each enhancement layer may provide better quality and/or spatial or temporal resolution. Correspondingly, the various types of scalability are called quality (or SNR, signal-to-noise ratio) scalability, spatial scalability, and temporal scalability.

In accordance with the techniques of this disclosure, blocks of any or all of the pictures of the enhancement layers (that is, layers above layer 602, such as pictures 620, 622, 624, 626, 630, 632, 634, and 636) may be predicted using data from both a lower layer and a current layer. That is, as discussed with respect to formula (2) above, a block in an enhancement layer may be predicted using a (potentially weighted) sum of a reference block from a base layer (R_{B}) and a reference block of the current enhancement layer (R_{E}).

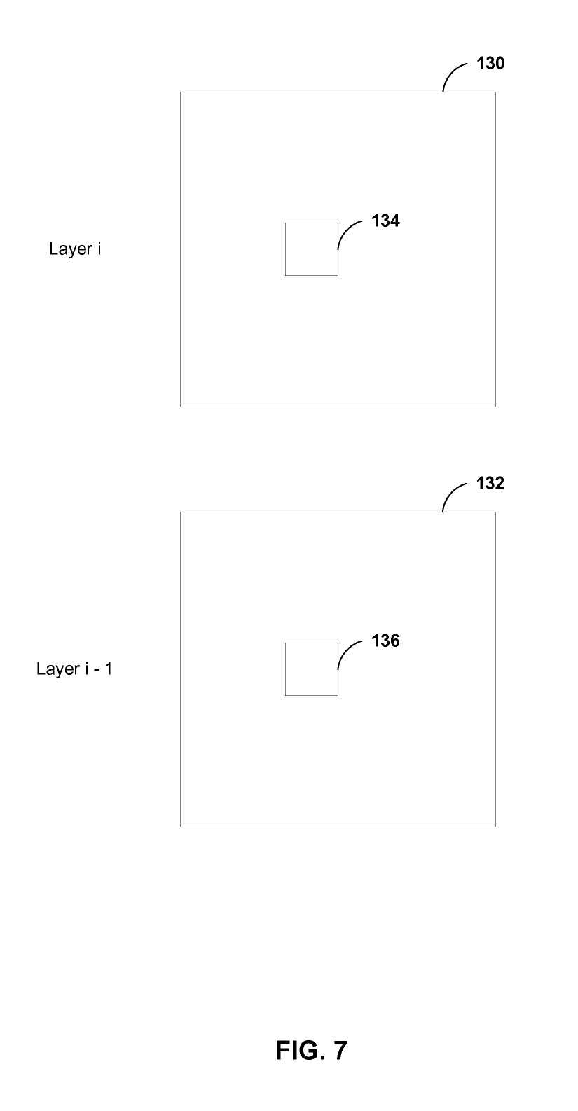

FIG. 7 is a conceptual diagram illustrating an example current block 134 of an enhancement layer that is predicted from data of a lower layer. In the example of FIG. 7, the enhancement layer is referred to as “layer i,” while the lower layer is referred to as “layer i−1.” In general, layer i−1 may be considered a base layer relative to layer i, as explained with respect to FIG. 6.

In this example, picture 130 includes block 134, while block 132 includes block 136. Block 136 is co-located with block 134. In SVC, pictures of lower layers may have a lower spatial resolution than pictures of higher layers. Therefore, the term “co-located” (or “collocated”), when referring to two blocks in different layers that are co-located, should be understood to mean that the two blocks correspond to one another, and not necessarily that the two blocks have the same absolute horizontal and vertical offsets from horizontal and vertical edges of the respective pictures.

When decoding layer i, it is assumed that lower layers (0, . . . i−1) have already been decoded and all information from lower layers is available for use to code layer i. For example, video encoder 20 may store decoded data of layers 0 to i−1 in reference frame memory 64, while video decoder 30 may store decoded data of layers 0 to i−1 in reference frame memory 82. For an enhancement layer block, besides regular INTRA and INTER mode described above, there is another prediction mode: INTRA_BL mode. In INTRA_BL mode, a block, such as block 134, is predicted from reconstructed co-located block of its base layer (layer i−1) as shown in FIG. 7. In this case, the reference block R_{B} is the co-located base layer block, that is, block 136. In some examples, if block 136 is spatially downsampled relative to block 134 (that is, has a lower spatial resolution), block 136 may be spatially upsampled to serve as a reference block R_{B} for coding block 134.

In accordance with the techniques of this disclosure, block 134 may correspond to a PU in an enhancement frame. A video coder, such as video encoder 20 or video decoder 30, may form an enhancement layer reference block (R_{E}) for block 134 using intra-prediction or inter-prediction. Moreover, in accordance with the techniques of this disclosure, the video coder may combine the data of R_{E} with a reference block formed from lower layer data (R_{B}), such as block 136.

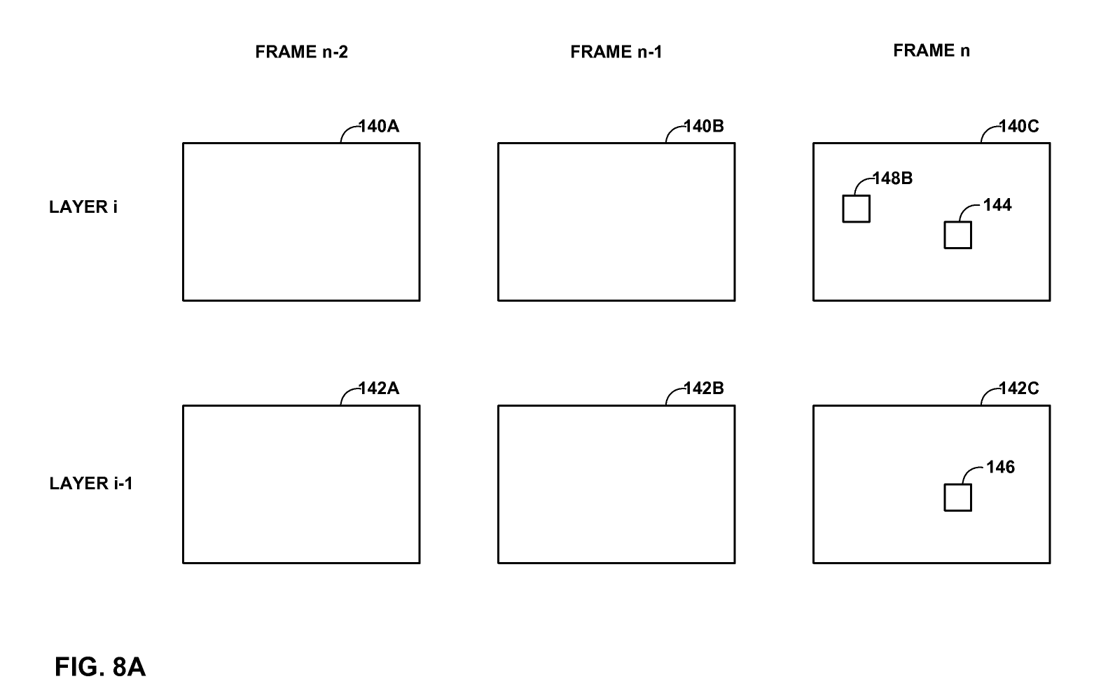

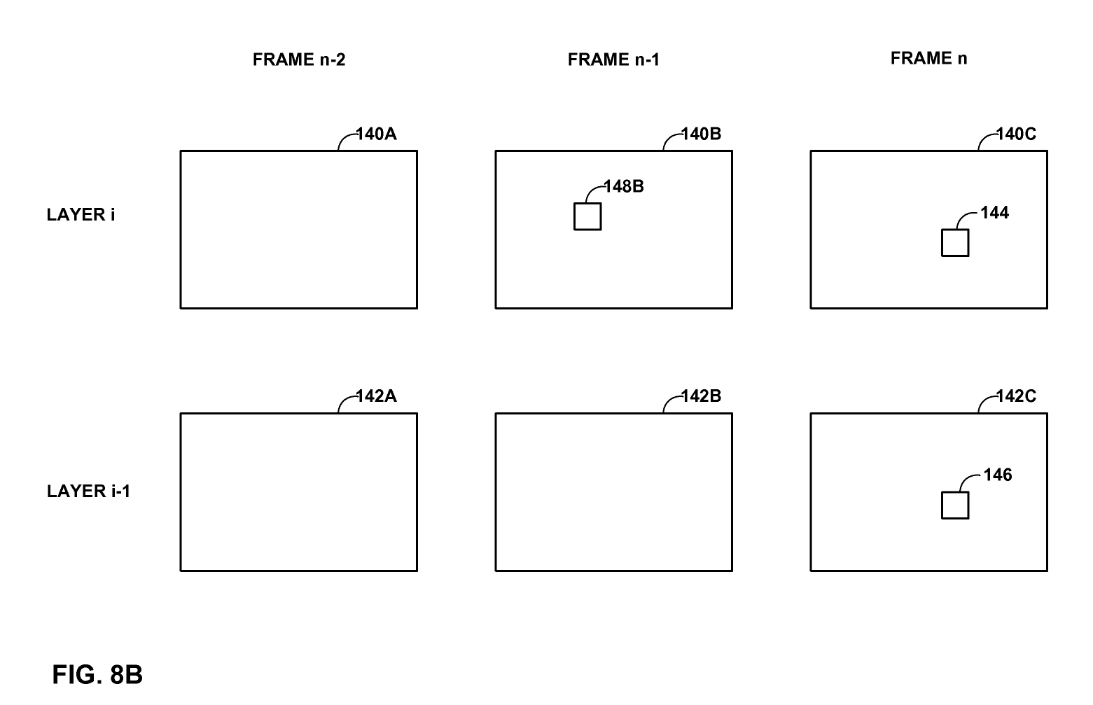

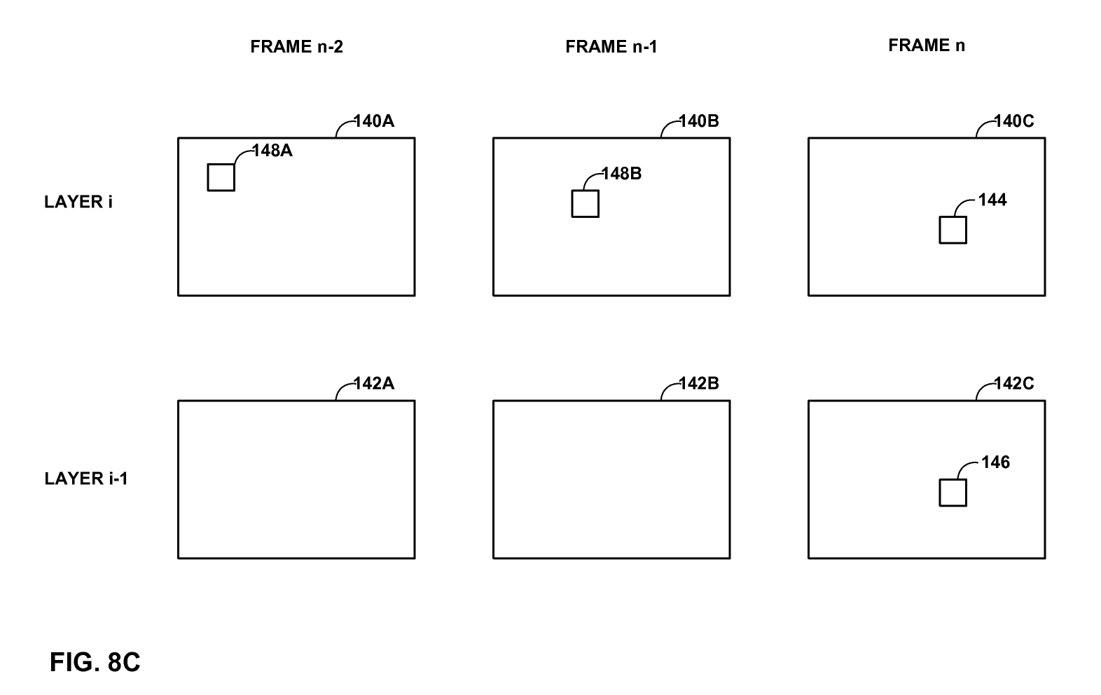

FIG. 8A is a conceptual diagram illustrating a block in an enhancement layer predicted from data of a base layer and data of the enhancement layer. FIG. 8A depicts pictures 140A-140C (pictures 140) and pictures 142A-142C (pictures 142). Pictures 140 correspond to an enhancement layer labeled “layer i,” while pictures 142 correspond to a base layer labeled “layer i−1.” Layer i−1 may correspond to the absolute base layer (e.g., if i=0) or a lower enhancement layer (e.g., if i>0).

Picture 140C includes block 144. As shown in FIG. 8A, block 144 is predicted from a single enhancement layer reference block 148B. Block 144 is also predicted from base layer reference block 146. Thus, block 144 is bi-layer texture predicted (e.g., according to intra-prediction), in that block 144 is predicted both from data of layer i and from layer i−1.

In accordance with the techniques of this disclosure, a video coder, such as video encoder 20 or video decoder 30, may form base layer reference data (R_{B}) corresponding to data of block 146 and enhancement layer reference data (R_{E}) corresponding to enhancement layer reference block 148B. For example, the video coder may also use a weighted sum to combine R_{E} with R_{B} to form predicted data for block 144.

After calculating the predicted data for block 144 from data of the enhancement layer and data of the base layer, a video encoder, such as video encoder 20, may calculate residual data for block 144, as a pixel-by-pixel difference between the predicted data and the original value of block 144. Alternatively, a video decoder, such as video decoder 30, may combine a residual data with the predicted data to reproduce the original block.

FIG. 8B is another conceptual diagram illustrating a block in an enhancement layer predicted from data of a base layer and data of the enhancement layer. FIG. 8B depicts pictures 140A-140C (pictures 140) and pictures 142A-142C (pictures 142). Pictures 140 correspond to an enhancement layer labeled “layer i,” while pictures 142 correspond to a base layer labeled “layer i−1.” Layer i−1may correspond to the absolute base layer (e.g., if i=0) or a lower enhancement layer (e.g., if i>0).

Picture 140C includes block 144. As shown in FIG. 8B, block 144 is predicted from a single enhancement layer reference block 148B in picture 140B. Block 144 is also predicted from base layer reference block 146. Thus, block 144 is bi-layer texture predicted (e.g., according to uni-directional inter-prediction), in that block 144 is predicted both from data of layer i and from layer i−1.

In accordance with the techniques of this disclosure, a video coder, such as video encoder 20 or video decoder 30, may form base layer reference data (R_{B}) corresponding to data of block 146 and enhancement layer reference data (R_{E}) corresponding to enhancement layer reference block 148B. For example, the video coder may also use a weighted sum to combine R_{E} with R_{B} to form predicted data for block 144.

After calculating the predicted data for block 144 from data of the enhancement layer and data of the base layer, a video encoder, such as video encoder 20, may calculate residual data for block 144, as a pixel-by-pixel difference between the predicted data and the original value of block 144. Alternatively, a video decoder, such as video decoder 30, may combine a residual data with the predicted data to reproduce the original block.

FIG. 8C is another conceptual diagram illustrating a block in an enhancement layer predicted from data of a base layer and data of the enhancement layer. FIG. 8C depicts pictures 140A-140C (pictures 140) and pictures 142A-142C (pictures 142). Pictures 140 correspond to an enhancement layer labeled “layer i,” while pictures 142 correspond to a base layer labeled “layer i−1.” Layer i−1 may correspond to the absolute base layer (e.g., if i=0) or a lower enhancement layer (e.g., if i>0).

Picture 140C includes block 144. As shown in FIG. 8C, block 144 is predicted from two enhancement layer reference blocks 148A, 148B. While enhancement layer reference blocks 148A, 148B are illustrated as being located in previous frames (e.g., Frame n−2 and Frame n−1), enhancement layer reference blocks 148A, 148B may be in any previous frame or future frame. Block 144 is also predicted from base layer reference block 146. Thus, block 144 is bi-layer texture predicted (e.g., according to bi-directional inter-prediction), in that block 144 is predicted both from data of layer i and from layer i−1.

In accordance with the techniques of this disclosure, a video coder, such as video encoder 20 or video decoder 30, may form base layer reference data (R_{B}) corresponding to data of block 146 and enhancement layer reference data (R_{E}) corresponding to enhancement layer reference blocks 148A, 148B. For example, the video coder may use a first weighted sum to combine data of enhancement layer reference blocks 148A and 148B. This first weighted sum may produce enhancement layer reference data R_{E}. The video coder may also use a second weighted sum to combine R_{E} with R_{B} to form predicted data for block 144.

After calculating the predicted data for block 144 from data of the enhancement layer and data of the base layer, a video encoder, such as video encoder 20, may calculate residual data for block 144, as a pixel-by-pixel difference between the predicted data and the original value of block 144. Alternatively, a video decoder, such as video decoder 30, may combine a residual data with the predicted data to reproduce the original block.

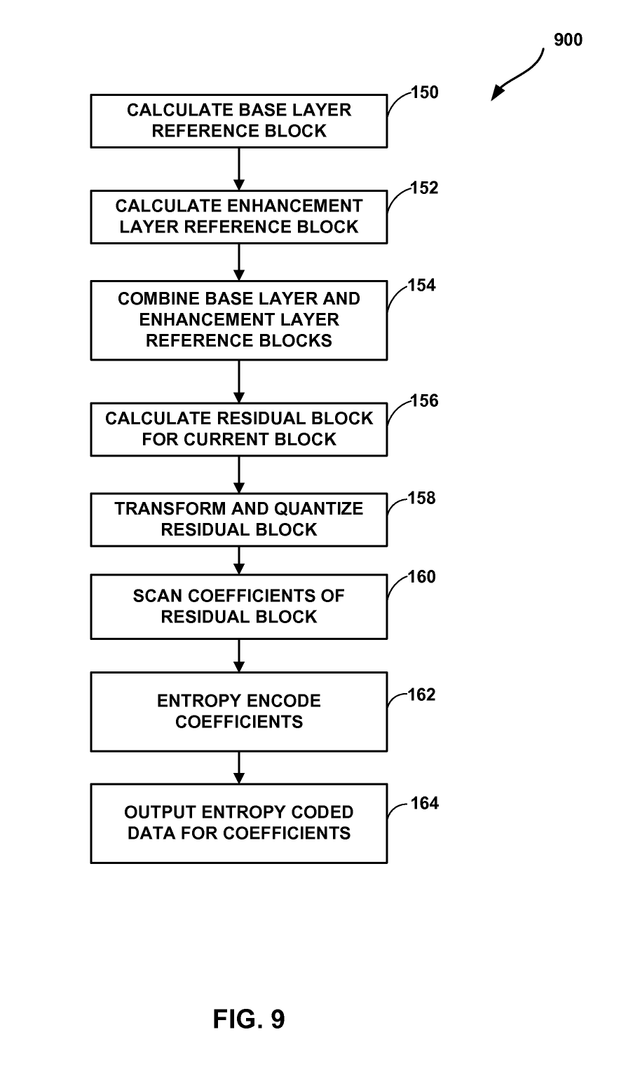

FIG. 9 is a flowchart illustrating an example method 900 for encoding a current block using bi-layer texture prediction. The current block may comprise a current CU or a portion of the current CU, such as a PU. Although described with respect to video encoder 20 (FIGS. 1 and 2), it should be understood that other devices may be configured to perform a method similar to that of FIG. 9. It is assumed that the current block corresponds to a block in an enhancement layer, e.g., “layer i” where i>0.

In this example, video encoder 20 calculates a base layer reference block (R_{B}) (150). For example, video encoder 20 may determine a value for a co-located block in a lower layer, such as layer i−1. Video encoder 20 also calculates an enhancement layer reference block (R_{E}) (152), e.g., using intra-prediction, uni-directional inter-prediction, or bi-directional inter-prediction. Video encoder 20 then combines the base layer and enhancement layer reference blocks (154), e.g., using a weighted sum, to form an actual reference block, also referred to as a predicted block, for the current block.

Video encoder 20 may then calculate a residual block for the current block, e.g., to produce a transform unit (TU) (156). To calculate the residual block, video encoder 20 may calculate a difference between the original, uncoded block and the predicted block for the current block. Video encoder 20 may then transform and quantize coefficients of the residual block (158). Next, video encoder 20 may scan the quantized transform coefficients of the residual block (160). During the scan, or following the scan, video encoder 20 may entropy encode the coefficients (162). For example, video encoder 20 may encode the coefficients using CAVLC or CABAC, or other techniques. Video encoder 20 may then output the entropy coded data of the block (164).

In this manner, the method 900 of FIG. 9 represents an example of a method including calculating a base layer reference block for a current block of an enhancement layer of video data, calculating an enhancement layer reference block for the current block, combining the base layer reference block and the enhancement layer reference block to form an actual reference block, and coding the current block using the actual reference block.

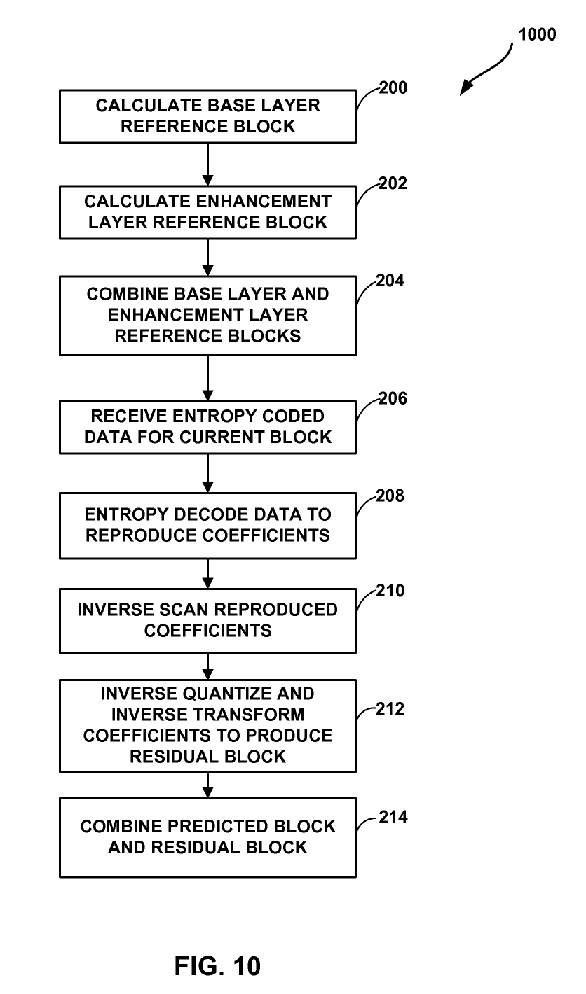

FIG. 10 is a flowchart illustrating an example method 1000 for decoding a current block of video data using bi-layer texture prediction. The current block may comprise a current CU or a portion of the current CU. Although described with respect to video decoder 30 (FIGS. 1 and 3), it should be understood that other devices may be configured to perform a method similar to that of FIG. 10. It is assumed that the current block corresponds to a block in an enhancement layer, e.g., “layer i” where i>0.

In this example, video decoder 30 calculates a base layer reference block (R_{B}) (200). For example, video decoder 30 may determine a value for a co-located block in a lower layer, such as layer i−1. Video decoder 30 also calculates an enhancement layer reference block (R_{E}) (202), e.g., using intra-prediction, uni-directional inter-prediction, or bi-directional inter-prediction. Video decoder 30 then combines the base layer and enhancement layer reference blocks (204) (e.g., using a weighted sum) to form an actual reference block, also referred to as a predicted block, for the current block.

Video decoder 30 may also receive entropy coded data for the current block, such as entropy coded data for coefficients of a residual block corresponding to the current block (206). Video decoder 30 may entropy decode the entropy coded data to reproduce coefficients of the residual block (208). Video decoder 30 may then inverse scan the reproduced coefficients (210), to create a block of quantized transform coefficients. Video decoder 30 may then inverse quantize and inverse transform the coefficients to produce a residual block (212). Video decoder 30 may ultimately decode the current block by combining the predicted block and the residual block (214).

In this manner, the method 1000 of FIG. 10 represents an example of a method including calculating a base layer reference block for a current block of an enhancement layer of video data, calculating an enhancement layer reference block for the current block, combining the base layer reference block and the enhancement layer reference block to form an actual reference block, and coding the current block using the actual reference block.

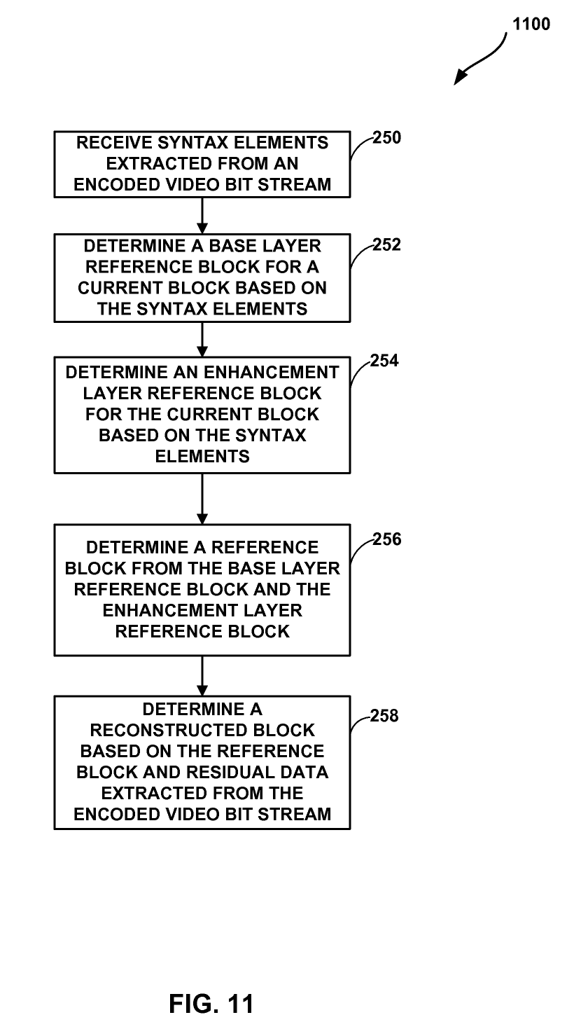

FIG. 11 is another flowchart illustrating an example method for decoding a block a current block of video data using bi-layer texture prediction. Process 1100 of FIG. 11 may be performed by a decoder (e.g., the decoder as shown in FIG. 3).

At block 250, the process 1100 may receive syntax elements extracted from an encoded video bit stream. At block 252, the process 1100 may determine a base layer reference block for a current block based on the syntax elements. In an embodiment, the current block is located in an enhancement layer of the video data. In a further embodiment, the base layer reference block is located in a base layer of the video data.

At block 254, the process 1100 may determine an enhancement layer reference block for the current block based on the syntax elements. In an embodiment, the enhancement layer reference block comprises a weighted sum of a first reference block located in the enhancement layer and a second reference block located in the enhancement layer.

At block 256, the process 1100 may determine a reference block from the base layer reference block and the enhancement layer reference block. At block 258, the process 1100 may determine a reconstructed block based on the reference block and residual data extracted from the encoded video bit stream.

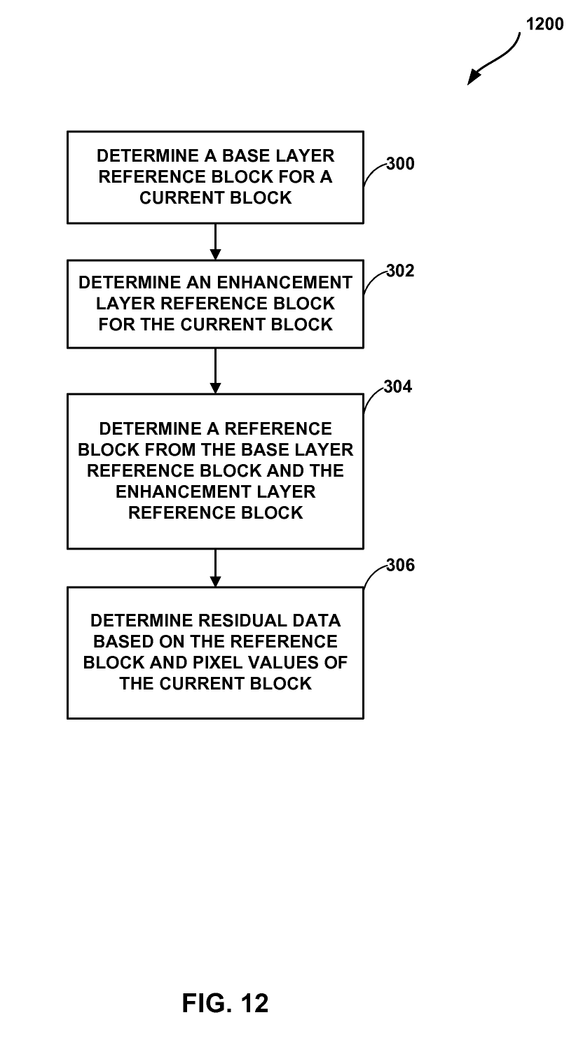

FIG. 12 is another flowchart illustrating an example method for encoding a current block using bi-layer texture prediction. Process 1200 of FIG. 12 may be performed by a encoder (e.g., the encoder as shown in FIG. 2).

At block 300, the process 1200 may determine a base layer reference block for a current block. In an embodiment, the current block is located in an enhancement layer of the video data. In a further embodiment, the base layer reference block is located in a base layer of the video data.

At block 302, the process 1200 may determine an enhancement layer reference block for the current block. In an embodiment, the enhancement layer reference block comprises a weighted sum of a first reference block located in the enhancement layer and a second reference block located in the enhancement layer.

At block 304, the process 1200 may determine a reference block from the base layer reference block and the enhancement layer reference block. At block 306, the process 1200 may determine residual data based on the reference block and pixel values of the current block.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be so provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus configured to code video data, the apparatus comprising:
a memory configured to store the video data, wherein the video data comprises a base layer and an enhancement layer, and wherein the enhancement layer comprises a current block; and
a processor in communication with the memory, the processor configured to:
determine a base layer reference block for the current block, wherein the base layer reference block is located in the base layer;
determine an enhancement layer reference block for the current block, wherein the enhancement layer reference block comprises a weighted sum of a first reference block located in the enhancement layer and a second reference block located in the enhancement layer; and
determine a reference block from the base layer reference block and the enhancement layer reference block.

2. The apparatus of claim 1, wherein the processor is further configured to determine residual data associated with the current block based on the reference block and pixel values of the current block.

3. The apparatus of claim 1, wherein the processor is further configured to:
determine a residual value associated with the current block as a difference between the current block and the reference block;
transform the residual value to determine transform coefficients; and
entropy encode the transform coefficients as an encoded bitstream.

4. The apparatus of claim 1, wherein the processor is further configured to determine a reconstructed block based on the reference block and residual data of an encoded video bit stream.

5. The apparatus of claim 1, wherein the processor is further configured to:
decode transform coefficients for a residual value of the current block;
inverse transform the transform coefficients to determine the residual value; and
determine a reconstructed block from the residual value and the reference block.

6. The apparatus of claim 1, wherein the processor is further configured to calculate a weighted sum of the base layer reference block and the enhancement layer reference block.

7. The apparatus of claim 6, wherein the processor is further configured to code a weight used to calculate the weighted sum in at least one of a slice header, a sequence parameter set (SPS), a picture parameter set (PPS), an adaptation parameter set (APS), a largest coding unit (LCU), a coding unit (CU), or a prediction unit (PU).

8. The apparatus of claim 6, wherein the processor is further configured to determine a weight used to calculate the weighted sum based at least in part on a prediction mode used to calculate the enhancement layer reference block.

9. The apparatus of claim 6, wherein the processor is further configured to apply individual weights to individual pixels of the base layer reference block and the enhancement layer reference block to determine the weighted sum.

10. The apparatus of claim 1, further comprising a device that comprises the memory and the processor selected from the group consisting of one or more of the following: a desktop computer, a notebook, a laptop computers, a tablet computer, a set-top box, a telephone handset, a smart phones, a smart pad, a television, a camera, a display device, a digital media player, a video gaming console, a video streaming device, and a device configured for wireless communication.

11. A method of decoding video data, the method comprising:
receiving syntax elements extracted from an encoded video bit stream;
determining a base layer reference block for a current block based on the syntax elements, wherein the current block is located in an enhancement layer of the video data, and wherein the base layer reference block is located in a base layer of the video data;
determining an enhancement layer reference block for the current block based on the syntax elements, wherein the enhancement layer reference block comprises a weighted sum of a first reference block located in the enhancement layer and a second reference block located in the enhancement layer;
determining a reference block from the base layer reference block and the enhancement layer reference block; and
determining a reconstructed block based on the reference block and residual data extracted from the encoded video bit stream.

12. The method of claim 11, wherein determining a reference block comprises calculating a weighted sum of the base layer reference block and the enhancement layer reference block.

13. The method of claim 12, further comprising decoding a weight used to calculate the weighted sum in at least one of a slice header, a sequence parameter set (SPS), a picture parameter set (PPS), an adaptation parameter set (APS), a largest coding unit (LCU), a coding unit (CU), or a prediction unit (PU).

14. The method of claim 12, further comprising determining a weight used to calculate the weighted sum based at least in part on a prediction mode used to calculate the enhancement layer reference block.

15. The method of claim 12, wherein calculating the weighted sum comprises applying individual weights to individual pixels of the base layer reference block and the enhancement layer reference block to determine the weighted sum.

16. The method of claim 11, wherein determining a reconstructed block comprises:
decoding transform coefficients for a residual value of the current block;
inverse transforming the transform coefficients to determine the residual value; and
determining the reconstructed block from the residual value and the reference block.

17. A method of encoding video data, the method comprising:
determining a base layer reference block for a current block, wherein the current block is located in an enhancement layer of the video data, and wherein the base layer reference block is located in a base layer of the video data;
determining an enhancement layer reference block for the current block, wherein the enhancement layer reference block comprises a weighted sum of a first reference block located in the enhancement layer and a second reference block located in the enhancement layer;
determining a reference block from the base layer reference block and the enhancement layer reference block; and
determining residual data based on the reference block and pixel values of the current block.

18. The method of claim 17, wherein determining a reference block comprises calculating a weighted sum of the base layer reference block and the enhancement layer reference block.

19. The method of claim 18, further comprising encoding a weight used to calculate the weighted sum in at least one of a slice header, a sequence parameter set (SPS), a picture parameter set (PPS), an adaptation parameter set (APS), a largest coding unit (LCU), a coding unit (CU), or a prediction unit (PU).

20. The method of claim 18, further comprising determining a weight used to calculate the weighted sum based at least in part on a prediction mode used to calculate the enhancement layer reference block.

21. The method of claim 18, wherein calculating the weighted sum comprises applying individual weights to individual pixels of the base layer reference block and the enhancement layer reference block to determine the weighted sum.

22. The method of claim 17, wherein generating residual data further comprises:
determining the residual data associated with the current block as a difference between the current block and the reference block;
transforming the residual data to determine transform coefficients; and
entropy encoding the transform coefficients as an encoded bitstream.

23. A non-transitory computer readable medium having stored thereon code that, when executed, causes an apparatus to:
determine a base layer reference block for a current block, wherein the current block is located in an enhancement layer of video data, and wherein the base layer reference block is located in a base layer of the video data;
determine an enhancement layer reference block for the current block, wherein the enhancement layer reference block comprises a weighted sum of a first reference block located in the enhancement layer and a second reference block located in the enhancement layer; and
determine a reference block from the base layer reference block and the enhancement layer reference block.

24. The medium of claim 23, further comprising code that, when executed, causes an apparatus to calculate a weighted sum of the base layer reference block and the enhancement layer reference block.

25. The medium of claim 24, further comprising code that, when executed, causes an apparatus to code a weight used to calculate the weighted sum in at least one of a slice header, a sequence parameter set (SPS), a picture parameter set (PPS), an adaptation parameter set (APS), a largest coding unit (LCU), a coding unit (CU), or a prediction unit (PU).

26. The medium of claim 24, further comprising code that, when executed, causes an apparatus to determine a weight used to calculate the weighted sum based at least in part on a prediction mode used to calculate the enhancement layer reference block.

27. The medium of claim 24, further comprising code that, when executed, causes an apparatus to apply individual weights to individual pixels of the base layer reference block and the enhancement layer reference block to determine the weighted sum.

28. A video coding device that codes video data, the video coding device comprising:
means for determining a base layer reference block for a current block, wherein the current block is located in an enhancement layer of video data, and wherein the base layer reference block is located in a base layer of the video data;
means for determining an enhancement layer reference block for the current block, wherein the enhancement layer reference block comprises a weighted sum of a first reference block located in the enhancement layer and a second reference block located in the enhancement layer; and
means for determining a reference block from the base layer reference block and the enhancement layer reference block.

29. The video coding device of claim 28, wherein means for combining comprises means for calculating a weighted sum of the base layer reference block and the enhancement layer reference block.

30. The video coding device of claim 29, further comprising means for coding a weight used to calculate the weighted sum in at least one of a slice header, a sequence parameter set (SPS), a picture parameter set (PPS), an adaptation parameter set (APS), a largest coding unit (LCU), a coding unit (CU), or a prediction unit (PU).

31. The video coding device of claim 29, further comprising determining a weight used to calculate the weighted sum based at least in part on a prediction mode used to calculate the enhancement layer reference block.

32. The video coding device of claim 29, wherein means for calculating comprises means for applying individual weights to individual pixels of the base layer reference block and the enhancement layer reference block to determine the weighted sum.
